(19) United States
(12) Patent Application Publication
(10) Pub. No.: US 2026/0171484 A1
(43) Pub. Date: Jun. 18, 2026

(54) SOLID ELECTROLYTE FOR A LITHIUM SECONDARY BATTERY

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Sun Ho Choi, Hwaseong-si (KR); Yong Jun Jang, Hwaseong-si (KR); Yong Gu Kim, Hwaseong-si (KR); Sang Heon Lee, Hwaseong-si (KR); Seong Hyeon Choi, Hwaseong-si (KR); Sa Heum Kim, Hwaseong-si (KR); Sung Man Cho, Hwaseong-si (KR); Sang Uck Lee, Bucheon-si (KR); Ji Hoon Kim, Ansan-si (KR); Ji Won Lee, Suwon-si (KR); Ji Seon Kim, Suwon-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/330,556

(22) Filed: Sep. 16, 2025

(30) Foreign Application Priority Data
Dec. 13, 2024 (KR) 10-2024-0186067

(51) Int. Cl. H01M 10/0562; H01M 10/0525; H01M 10/42

(52) U.S. Cl. CPC H01M 10/0562; H01M 10/0525; H01M 10/4235; H01M 2300/008

(57) ABSTRACT

A solid electrolyte includes a compound represented by LiₐA1_{b1}A2_{b2}A3_{b3}(Y)_{c}(X)_{d}. Li is lithium. A1, A2, and A3 are different from each other and A1, A2, and A3 each comprise antimony (Sb), tin (Sn), germanium (Ge), silicon (Si), or phosphorus (P). Y comprises oxygen (O), sulfur(S), selenium (Se), or tellurium (Te). X comprises chlorine (Cl), bromine (Br), iodine (I), or X1ₑX2₁₋ₑ. X1 and X2 are different from each other and X1 and X2 each comprise Cl, Br, or I. Further, a satisfies 5≤a≤8, b1, b2, and b3 each satisfy 0≤b1≤1, 0≤b2≤1, 0≤b3≤1, b1+b2+b3=1, c satisfies 4≤c≤6, d satisfies 0≤d≤2, and e satisfies 0<e<1.

### CROSS-REFERENCE TO RELATED APPLICATION

This application claims, under 35 U.S.C. § 119(a), the benefit of and priority to Korean Patent Application No. 10-2024-0186067, filed on Dec. 13, 2024, the entire contents of which are incorporated herein by reference.

### TECHNICAL FIELD

The present disclosure relates to a solid electrolyte for a lithium secondary battery.

### BACKGROUND

Currently, lithium secondary batteries are being used in small electronic devices such as mobile phones, tablets, and the like, and in large transportation vehicles such as electric vehicles, and the like. Accordingly, the demand for stability is increasing, and thorough research is ongoing into solid electrolytes to replace the liquid electrolytes of existing lithium secondary batteries.

Currently commercialized lithium secondary batteries have safety issues due to flammable organic liquid electrolytes. Hence, using a solid electrolyte that is non-flammable is regarded as blocking the root cause of the safety problem. In addition, solid electrolytes have high packing efficiency, which may reduce the volume and weight of lithium secondary batteries.

Synthesizing and studying solid electrolytes with various crystal structures and compositions requires a lot of time and effort. Therefore, many attempts have been made to calculate and predict the properties of solid electrolytes, such as lithium ion conductivity, and the like. However, all of these attempts are focused on developing solid electrolytes with high lithium ion conductivity. Even if a solid electrolyte with high lithium ion conductivity is developed, when it is applied to an actual cell, the cell may not operate properly due to micro-short circuits within the electrode.

The statements in this Background section merely provide background information related to the present disclosure and may not constitute prior art.

### SUMMARY

Various aspects are to provide a solid electrolyte for a lithium secondary battery having excellent stability and high lithium ion conductivity when applied to an actual cell.

Various aspects are not limited to the foregoing. Various aspects should be clearly understood through the following description and be realized by the means described in the claims and combinations thereof.

Various aspects provide a solid electrolyte including a compound represented by Chemical Formula 1 below:

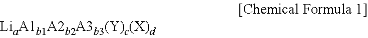

wherein: Li is lithium; A1, A2, and A3 are different from each other and may each include antimony (Sb), tin (Sn), germanium (Ge), silicon (Si), or phosphorus (P); Y may include oxygen (O), sulfur(S), selenium (Se), or tellurium (Te); X may include chlorine (Cl), bromine (Br), iodine (I), or X1ₑX2₁₋ₑ; X1 and X2 are different from each other and may each include Cl, Br, or I; a satisfies 5≤a≤8; b1, b2, and b3 each satisfy 0≤b1≤1, 0≤b2≤1, 0≤b3≤1, and b1+b2+b3=1; c satisfies 4≤c≤6; d satisfies 0≤d≤2; and e satisfies 0<e<1.

The compound may be one in which b3 is 0, A1 and A2 are different from each other, and A1 and A2 each include Sb, Sn, or Ge.

The solid electrolyte may include a compound represented by Chemical Formula 2-1 below:

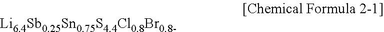

The solid electrolyte may include a compound represented by Chemical Formula 2-2 below:

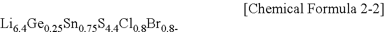

The solid electrolyte may include a compound represented by Chemical Formula 2-3 below:

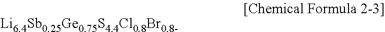

The compound may be one in which b3 is 0, A1 and A2 are different from each other, and A1 and A2 each include Si or Ge.

The solid electrolyte may include a compound represented by Chemical Formula 3-1 below:

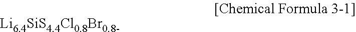

The solid electrolyte may include a compound represented by Chemical Formula 3-2 below:

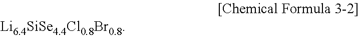

The solid electrolyte may include a compound represented by Chemical Formula 3-3 below:

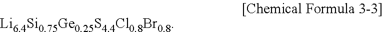

The solid electrolyte may include a compound represented by Chemical Formula 4 below:

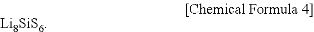

The compound may be one in which A1, A2, and A3 are different from each other and A1, A2, and A3 each include Sb, Ge, or P.

The solid electrolyte may include a compound represented by Chemical Formula 5-1 below:

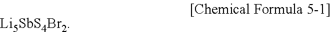

The solid electrolyte may include a compound represented by Chemical Formula 5-2 below:

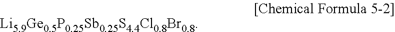

The solid electrolyte may include a compound represented by Chemical Formula 5-3 below:

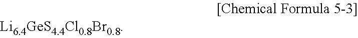

Various aspects provide a lithium secondary battery including a solid electrolyte. The solid electrolyte includes a compound represented by Chemical Formula 1 below:

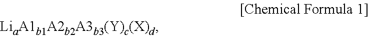

wherein: Li is lithium; A1, A2, and A3 are different from each other and may each include antimony (Sb), tin (Sn), germanium (Ge), silicon (Si), or phosphorus (P); Y may include oxygen (O), sulfur(S), selenium (Se), or tellurium (Te); X may include chlorine (Cl), bromine (Br), iodine (I), or X1ₑX2₁₋ₑ; X1 and X2 are different from each other and may each include Cl, Br, or I; a satisfies 5≤a≤8; b1, b2, and b3 each satisfy 0≤b1≤1, 0≤b2≤1, 0≤b3≤1, and b1+b2+b3=1; c satisfies 4≤c≤6; d satisfies 0≤d≤2; and e satisfies 0<e<1.

The compound may be one in which b3 is 0, A1 and A2 are different from each other, and A1 and A2 each include Sb, Sn, or Ge.

The solid electrolyte may include a compound represented by Chemical Formula 2-1 below:

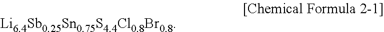

The solid electrolyte may include a compound represented by Chemical Formula 2-2 below:

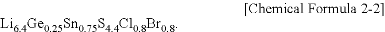

The solid electrolyte may include a compound represented by Chemical Formula 2-3 below:

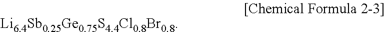

The compound may be one in which b3 is 0, A1 and A2 are different from each other, and A1 and A2 each include Si or Ge.

### DETAILED DESCRIPTION

The above and other objects, features and advantages of the present disclosure should be more clearly understood from the following embodiments taken in conjunction with the accompanying drawings. However, the present disclosure is not limited to embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures are depicted as being larger than the actual sizes thereof.

It should be understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless specified otherwise, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

Herein, excellent moisture stability of a solid electrolyte may mean that the solid electrolyte is able to maintain performance and physicochemical properties thereof without causing chemical reaction or undergoing structural change when in contact with moisture (dihydrogen monoxide, H₂O) in the air. The solid electrolyte according to an embodiment of the present disclosure does not react with moisture to generate hydrogen sulfide (H₂S) and is able to maintain properties such as strength, ductility, lithium ion conductivity, and the like.

Herein, excellent interface stability of a solid electrolyte may mean that the solid electrolyte is able to maintain structural stability without causing chemical reaction at the interface of the two components when in contact with a cathode active material and/or an anode active material. The solid electrolyte according to an embodiment of the present disclosure does not react with the cathode active material and/or the anode active material, and thus is not decomposed or deformed, and is able to form a stable interface with the cathode active material and/or the anode active material, thereby lowering interface resistance within the electrode.

Herein, excellent voltage stability of a solid electrolyte may mean that the solid electrolyte is able to maintain high physicochemical stability within a specific voltage range. The solid electrolyte according to an embodiment of the present disclosure may be maintained in a stable state without undergoing chemical decomposition or structural change in a low-voltage range and/or a high-voltage range.

The solid electrolyte according to an embodiment of the present disclosure may include a sulfide-based solid electrolyte and may include a compound represented by Chemical Formula 1 below:

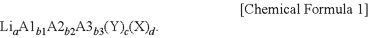

In Chemical Formula 1, Li is lithium, and A1, A2, and A3 are different from each other and may each include antimony (Sb), tin (Sn), germanium (Ge), silicon (Si), or phosphorus (P).

Y may include oxygen (O), sulfur(S), selenium (Se), or tellurium (Te).

X may include chlorine (Cl), bromine (Br), iodine (I), or X1ₑX2₁₋ₑ. X1 and X2 are different from each other and may each include Cl, Br, or I.

In Chemical Formula 1, a, b1, b2, b3, c, d, and e may satisfy 5≤a≤8, 0≤b1≤1, 0≤b2≤1, 0≤b3≤1, b1+b2+b3=1, 4≤c≤6, 0≤d≤2, and 0<e<1.

The solid electrolyte includes those in which b3 is 0, A1 and A2 are different from each other, and A1 and A2 each include Sb, Sn, or Ge. The solid electrolyte includes a compound represented by Chemical Formula 2-1 below, a compound represented by Chemical Formula 2-2 below, or a compound represented by Chemical Formula 2-3 below:

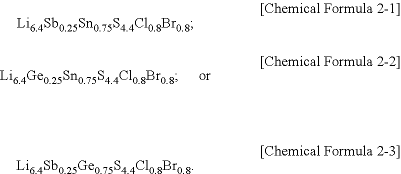

The compound represented by Chemical Formula 2-1 or the compound represented by Chemical Formula 2-2 has excellent moisture stability, preventing generation of hydrogen sulfide gas when in contact with moisture in the air.

The moisture stability may be evaluated by calculating the hydrogen sulfide gas generation reaction energy of each compound using density functional theory (DFT) during computer simulation. This process is as follows.

A pseudo-binary reaction equation for a product composition (C) resulting from reaction between the solid electrolyte (SE) to be calculated and moisture (H₂O) is designed with equation (1):

$${C}_{p roducts} ( SE , {H}_{2} O , x ) = x \cdot C ( S E ) + ( 1 - x ) C ( {H}_{2} O ) - ( 1 ) .$$

The reaction energy of this equation is calculated as follow equation (2):

$${E}_{reaction} ( SE , {H}_{2} O , x ) = {E}_{e q} ( {C}_{p roducts} ( SE , {H}_{2} O , x ) ) - E ( {C}_{p roducts} ( SE , {H}_{2} O , x ) ) - ( 2 )$$

where eq represents the phase equilibrium state of the products of reaction equation (1).

By applying this equation to the range 0<x<1, E_{reaction} for x is calculated, and then the reaction at x with the lowest reaction energy is determined to be a reaction equation for the solid electrolyte and moisture (H₂O).

To compare reaction energies between various solid electrolytes, the reaction equation is normalized to H₂S.

The final hydrogen sulfide gas formation energy may be obtained by dividing the reaction energy by the conversion factor, which considers the conversion ratio of sulfur contained in the solid electrolyte, which is a reactant, to the formation of hydrogen sulfide gas.

An example of obtaining the hydrogen sulfide gas formation energy of Li₆PS₅Cl in this way is as follows.
Pseudo-binary reaction equation obtained using Li₆PS₅Cl and H₂O

$${C}_{products} ( {Li}_{6} P {S}_{5} Cl , {H}_{2} O , x ) = x \cdot {Li}_{6} P {S}_{5} Cl + ( 1 - x ) \cdot {H}_{2} O$$

The lowest reaction energy is obtained when x=0.2

$$\begin{matrix}{E}_{r e action} ( {Li}_{6} P {S}_{5} Cl , {H}_{2} O , 0.2 ) = \begin{matrix}{E}_{e q} ( 0.2 {Li}_{3} {PO}_{4} + 0.4 LiHS + 0.6 {H}_{2} S + \\ 0.2 LiCl ) - ( 0.2 E ( L {i}_{6} P {S}_{5} Cl ) + 0.8 E ( {H}_{2} O ) )\end{matrix} \\ = - 10.6 eV / atom\end{matrix}$$

Normalized to H₂S equivalent of 0.6

$${E}_{r e a c t i o n} = - 10 \text{.60} / 0.6 = - 1 7.67 eV / atom$$

Conversion factor, reflecting that 0.6 H₂S is formed from S contained in 0.2

$$L {i}_{6} P {S}_{5} Cl , = 0.6 / 0.2 \times 5 = 0.6$$

$${E}_{r e action} = - 1 7.67 eV / atom \times 0.6 = - 1 0.6 eV / atom$$

The hydrogen sulfide gas formation energy (H₂S E_{form}) of the solid electrolyte according to embodiments of the present disclosure is shown in Table 1 below.

TABLE 1

| Classification | Composition | H₂S E_{form} [eV] |
|---|---|---|
| Example | Li_{6.4}Sb_{0.25}Sn_{0.75}S_{4.4}Cl_{0.8}Br_{0.8} | 0.598 |
| Example | Li_{6.4}Ge_{0.25}Sn_{0.75}S_{4.4}Cl_{0.8}Br_{0.8} | 0.585 |
| Comparative Example | Li_{6.5}Si_{0.5}P_{0.5}S₅Cl | −0.243 |
| Comparative Example | Li₆PS₅Cl | −0.440 |

Referring to Table 1, phosphorus (P) and silicon (Si) are easily formed into Li₃PO₄ and Li₂SiO₃ as represented in the following schemes, and hydrogen sulfide is generated from hydrogen (H) remaining in the process:

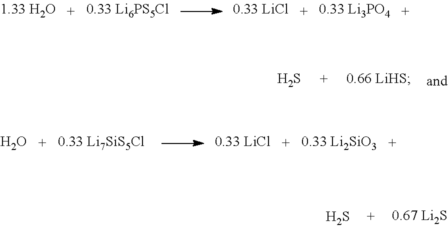

In contrast, antimony (Sb) of Example is formed into Li₂SO₄ and Li₃SbS₃ as represented in the following scheme, and since sulfur(S) reacts with antimony (Sb), it is difficult for hydrogen sulfide generation reaction to occur:

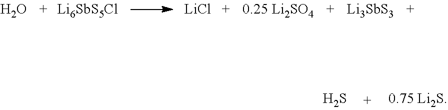

In addition, germanium (Ge) and tin (Sn) of Example are competitively formed into Li₄GeO₄ and LiSnO₃ as represented in the following scheme, making it difficult for hydrogen sulfide generation reaction to occur:

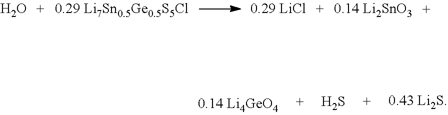

In addition, the compound represented by Chemical Formula 2-2 or the compound represented by Chemical Formula 2-3 has excellent cathode interface stability, and thus, when in contact with a cathode active material such as NCM 811, and the like, such a compound does not react with the cathode active material to form an intermediate phase, and is able to maintain physicochemical stability.

The cathode interface stability may be evaluated by calculating the interface reaction energy. This process is as follows:

$${C}_{interface} ( {C}_{SE} , {C}_{electrode} , x ) \to x {C}_{SE} + ( 1 - x ) {C}_{electrode} \qquad ( expression 1 )$$

(C_{interface}(C_{SE}, C_{electrode}, x): composition of interface, C_{SE}: composition of solid electrolyte in contact, C_{electrode}: composition of active material in contact, 0<x<1)

The composition formula of expression 1 is changed to an equation for calculating interface energy as below:

$${E}_{interface} ( SE , electrode , x ) = xE ( SE ) + ( 1 + x ) E ( electrode ) . \qquad ( expression 2 )$$

The stability between the solid electrolyte and the active material may be evaluated by the decomposition energy (AED) between the two components.

$$Δ {E}_{D} ( SE , electrode , x ) = {E}_{eq} ( {C}_{SE} , {C}_{electrode} , x ) ) - \text{} {E}_{interface} ( SE , electrode , x ) \qquad ( expression 3 )$$

(E_{eq}: interface energy at equilibrium, E_{interface}: interface composition energy to be obtained)

The reaction energy considering the equivalent number (0-1) in an equilibrium state between the solid electrolyte and the active material may be defined as ΔE_{D,mutual}(SE, electrode, x) below:

$$Δ {E}_{D , mutual} ( SE , electrode , x ) = Δ {E}_{D} ( SE , electrode , x ) - x Δ {E}_{D} ( SE ) - ( 1 - x ) Δ {E}_{D} ( electrode ) \qquad ( expression 4 )$$

(ΔE_{D}(SE): decomposition energy of solid electrolyte, ΔE_{D}(electrode): decomposition energy of active material).

The energy when x=xₘ at which energy is minimized is as follows:

$$Δ {E}_{D , mutual} ( SE , electrode , x ) = Δ {E}_{D , mutual} ( SE , electrode , {x}_{m} ) . \qquad ( expression 5 )$$

Using ΔE_{D,mutual}(SE, electrode, x) thus obtained, the interface reaction energy between the solid electrolyte and the cathode active material may be calculated. The decomposition energy and equilibrium energy of each composition may be obtained using the Materials Project database, whereby the cathode interface stability of each composition may be calculated and evaluated.

The interface reaction energy (Eᵢₙₜ) of the solid electrolyte according to embodiments of the present disclosure for the cathode active material is shown in Table 2 below.

TABLE 2

| Classification | Composition | Eᵢₙₜ [eV] |
|---|---|---|
| Example | Li_{6.4}Ge_{0.25}Sn_{0.75}S_{4.4}Cl_{0.8}Br_{0.8} | −0.339 |
| Example | Li_{6.4}Sb_{0.25}Ge_{0.75}S_{4.4}Cl_{0.8}Br_{0.8} | −0.340 |
| Comparative Example | Li_{5.9}Si_{0.5}P_{0.5}S_{4.4}Cl_{0.8}Br_{0.8} | −0.418 |
| Comparative Example | Li₆PS₅Cl | −0.424 |

Referring to Table 2, compounds containing silicon (Si) and phosphorus (P) are found to have poor cathode interface stability.

The solid electrolyte may include those in which b3 is 0, A1 and A2 are different from each other, and A1 and A2 each include Si or Ge. The solid electrolyte includes a compound represented by Chemical Formula 3-1 below, a compound represented by Chemical Formula 3-2 below, a compound represented by Chemical Formula 3-3 below, or a compound represented by Chemical Formula 4 below:

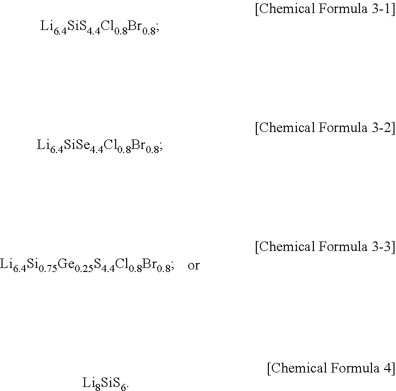

The compound represented by Chemical Formula 3-1, the compound represented by Chemical Formula 3-2, or the compound represented by Chemical Formula 3-3 may have excellent stability in a low-voltage range.

The voltage stability of the solid electrolyte may be evaluated through an electrochemical window (ECW). The electrochemical window (ECW) is a range in which the solid electrolyte is stable without decomposition even when voltage changes, and is the value obtained by subtracting the reduction potential from the oxidation potential. Since the solid electrolyte is in contact with the electrode, a wide electrochemical window (ECW) may be advantageous for stable cell operation. The process of determining the electrochemical window (ECW) is as follows.

To perform the electrochemical window (ECW) calculation using pymatgen and the Material API, first, the chemical potential value of lithium (Li) is defined using the Materials Project database. By creating a phase diagram in which a desired composition in which lithium (Li) is present is composed of materials to be decomposed, it is possible to learn about the decomposed material depending on the voltage range of desired materials. In this way, the electrochemical window (ECW) may be calculated.

The results of evaluating the low-voltage stability (Low V) of the solid electrolyte according to embodiments of the present disclosure are shown in Table 3 below.

TABLE 3

| Classification | Composition | Low V [eV] |
|---|---|---|
| Example | Li_{6.4}SiS_{4.4}Cl_{0.8}Br_{0.8} | 1.497 |
| Example | Li_{6.4}SiSe_{4.4}Cl_{0.8}Br_{0.8} | 1.552 |
| Example | Li_{6.4}Si_{0.75}Ge_{0.25}S_{4.4}Cl_{0.8}Br_{0.8} | 1.620 |
| Comparative Example | Li_{5.9}Si_{0.5}P_{0.5}S_{4.4}Cl_{0.8}Br_{0.8} | 1.689 |
| Comparative Example | Li₆PS₅Cl | 1.708 |

Referring to Table 3, the solid electrolyte according to embodiments of the present disclosure is found to have vastly superior low-voltage stability.

The compound represented by Chemical Formula 3-1, the compound represented by Chemical Formula 3-3, or the compound represented by Chemical Formula 4 has excellent anode interface stability, and thus, when in contact with an anode active material such as lithium metal, and the like, such a compound does not react with the anode active material to form an intermediate phase and is able to maintain physicochemical stability.

The anode interface stability may be calculated and evaluated in the same manner as the cathode interface stability described above.

The interface reaction energy (Eᵢₙₜ) of the solid electrolyte according to embodiments of the present disclosure for the anode active material is shown in Table 4 below.

TABLE 4

| Classification | Composition | Eᵢₙₜ [eV] |
|---|---|---|
| Example | Li_{6.4}SiS_{4.4}Cl_{0.8}Br_{0.8} | −0.347 |
| Example | Li_{6.4}Si_{0.75}Ge_{0.25}S_{4.4}Cl_{0.8}Br_{0.8} | −0.357 |
| Example | Li₈SiS₆ | −0.322 |
| Comparative Example | Li_{6.15}Si_{0.75}P_{0.25}S_{4.4}Cl_{0.8}Br_{0.8} | −0.399 |
| Comparative Example | Li_{6.15}Si_{0.5}Ge_{0.25}P_{0.25}S_{4.4}Cl_{0.8}Br_{0.8} | −0.409 |
| Comparative Example | Li₆PS₅Cl | −0.539 |

Referring to Table 4, the solid electrolyte according to embodiments of the present disclosure is found to have excellent anode interface stability.

The solid electrolyte may include those in which A1, A2, and A3 are different from each other and A1, A2, and A3 each include Sb, Ge, or P. The solid electrolyte includes a compound represented by Chemical Formula 5-1 below, a compound represented by Chemical Formula 5-2 below, or a compound represented by Chemical Formula 5-3 below:

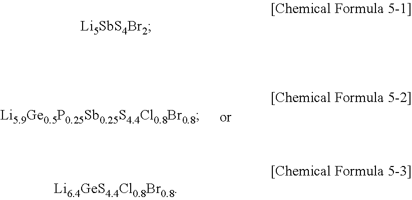

The compound represented by Chemical Formula 5-1, the compound represented by Chemical Formula 5-2, or the compound represented by Chemical Formula 5-3 may have excellent stability in a high-voltage range.

The high-voltage stability may be calculated and evaluated in the same manner as the low-voltage stability described above.

The results of evaluating the high-voltage stability (High V) of the solid electrolyte according to embodiments of the present disclosure are shown in Table 5 below.

TABLE 5

| Classification | Composition | High V [eV] |
|---|---|---|
| Example | Li₅SbS₄Br₂ | 2.299 |
| Example | Li_{5.9}Ge_{0.5}P_{0.25}Sb_{0.25}S_{4.4}Cl_{0.8}Br_{0.8} | 2.288 |
| Example | Li_{6.4}GeS_{4.4}Cl_{0.8}Br_{0.8} | 2.129 |
| Comparative Example | Li_{5.4}P_{0.25}Sb_{0.75}S_{4.4}Cl_{0.8}Br_{0.8} | 2.229 |
| Comparative Example | Li₆PS₅Cl | 2.129 |

Referring to Table 5, the solid electrolyte according to embodiments of the present disclosure is found to have vastly superior high-voltage stability.

According to an embodiment of the present disclosure, a solid electrolyte for a lithium secondary battery having excellent moisture stability, cathode interface stability, anode interface stability, high-voltage stability, and low-voltage stability can be obtained when applied to an actual cell.

According to an embodiment of the present disclosure, a solid electrolyte for a lithium secondary battery having excellent stability and high lithium ion conductivity can be obtained.

The effects of the present disclosure are not limited to the foregoing. It should be understood that the effects of the present disclosure include all effects that can be inferred from the description of the present disclosure.

Although various aspects have been described, those having ordinary skill in the art should appreciate that the present disclosure may be embodied in other specific forms without changing the technical spirit or essential features thereof. Thus, embodiments described above should be understood to be non-limiting and illustrative in every way.

What is claimed is:

1. A solid electrolyte, comprising a compound represented by Chemical Formula 1 below: 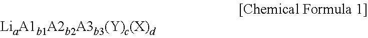
wherein Li is lithium,
A1, A2, and A3 are different from each other and A1, A2, and A3 each comprise antimony (Sb), tin (Sn), germanium (Ge), silicon (Si), or phosphorus (P),
Y comprises oxygen (O), sulfur(S), selenium (Se), or tellurium (Te),
X comprises chlorine (Cl), bromine (Br), iodine (I), or X1ₑX2₁₋ₑ,
X1 and X2 are different from each other and X1 and X2 each comprise Cl, Br, or I,
a satisfies 5≤a≤8,
b1, b2, and b3 each satisfy 0≤b1≤1, 0≤b2≤1, 0≤b3≤1, and b1+b2+b3=1,
c satisfies 4≤c≤6,
d satisfies 0≤d≤2, and
e satisfies 0<e<1.

2. The solid electrolyte of claim 1, wherein
b3 is 0,
A1 and A2 are different from each other, and
A1 and A2 each comprise Sb, Sn, or Ge.

3. The solid electrolyte of claim 1, comprising a compound represented by Chemical Formula 2-1 below:

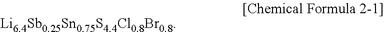

4. The solid electrolyte of claim 1, comprising a compound represented by Chemical Formula 2-2 below:

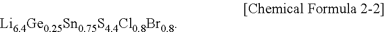

5. The solid electrolyte of claim 1, comprising a compound represented by Chemical Formula 2-3 below:

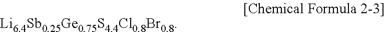

6. The solid electrolyte of claim 1, wherein b3 is 0, A1 and A2 are different from each other, and A1 and A2 each comprise Si or Ge.

7. The solid electrolyte of claim 1, comprising a compound represented by Chemical Formula 3-1 below:

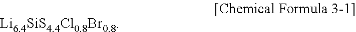

8. The solid electrolyte of claim 1, comprising a compound represented by Chemical Formula 3-2 below:

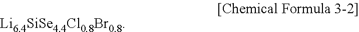

9. The solid electrolyte of claim 1, comprising a compound represented by Chemical Formula 3-3 below:

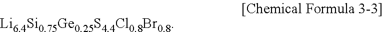

10. The solid electrolyte of claim 1, comprising a compound represented by Chemical Formula 4 below:

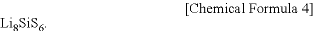

11. The solid electrolyte of claim 1, wherein A1, A2, and A3 are different from each other and A1, A2, and A3 each comprise Sb, Ge, or P.

12. The solid electrolyte of claim 1, comprising a compound represented by Chemical Formula 5-1 below:

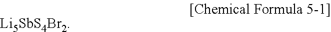

13. The solid electrolyte of claim 1, comprising a compound represented by Chemical Formula 5-2 below:

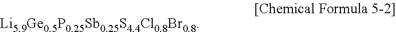

14. The solid electrolyte of claim 1, comprising a compound represented by Chemical Formula 5-3 below:

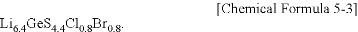

15. A lithium secondary battery including a solid electrolyte, the solid electrolyte comprising a compound represented by Chemical Formula 1 below: 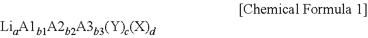
wherein Li is lithium,
A1, A2, and A3 are different from each other and A1, A2, and A3 each comprise antimony (Sb), tin (Sn), germanium (Ge), silicon (Si), or phosphorus (P),
Y comprises oxygen (O), sulfur(S), selenium (Se), or tellurium (Te),
X comprises chlorine (Cl), bromine (Br), iodine (I), or X1ₑX2₁₋ₑ,
X1 and X2 are different from each other and X1 and X2 each comprise Cl, Br, or I,
a satisfies 5≤a≤8,
b1, b2, and b3 each satisfy 0≤b1≤1, 0≤b2≤1, 0≤b3≤1, b1+b2+b3=1,
c satisfies 4≤c≤6,
d satisfies 0≤d≤2, and
e satisfies 0<e<1.

16. The lithium secondary battery of claim 15, wherein
b3 is 0,
A1 and A2 are different from each other, and
A1 and A2 each comprise Sb, Sn, or Ge.

17. The lithium secondary battery of claim 15, comprising a compound represented by Chemical Formula 2-1 below:

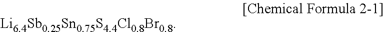

18. The lithium secondary battery of claim 15, comprising a compound represented by Chemical Formula 2-2 below:

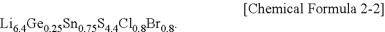

19. The lithium secondary battery of claim 15, comprising a compound represented by Chemical Formula 2-3 below:

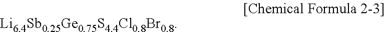

20. The lithium secondary battery of claim 15, wherein b3 is 0, A1 and A2 are different from each other, and A1 and A2 each comprise Si or Ge.
